(19) United States
(12) Patent Application Publication
(10) Pub. No.: US 2021/0107200 A1
(43) Pub. Date: Apr. 15, 2021

(54) Microcapillary Wire Coating Die Assembly

(71) Applicant: Dow Global Technologies LLC, Midland, MI (US)

(72) Inventors: Wenyi Huang, Midland, MI (US); Mohamed Esseghir, Collegeville, PA (US); Scott R. Kaleyta, Midland, MI (US); Chester J. Kmiec, Collegeville, PA (US); Robert E. Wrisley, Midland, MI (US)

(21) Appl. No.: 16/464,348

(22) PCT Filed: Nov. 13, 2017
(86) PCT No.: PCT/US2017/061269

§ 371 Date: May 28, 2019

Related U.S. Application Data
(60) Provisional application No. 62/427,358, filed on Nov. 29, 2016.

(51) Int. Cl. B29C 48/34; B29C 48/05; B29C 48/11; B29C 48/12; B29C 48/154; B29C 48/21; B29C 48/25; B29C 48/285

(52) U.S. Cl. CPC B29C 48/34; B29C 48/05; B29C 48/11; B29C 48/12; B29L 2031/3462; B29C 48/21; B29C 48/2566; B29C 48/25686; B29C 48/2883; B29C 48/154

(57) ABSTRACT

Polymeric coatings comprising microcapillary structures are applied to a wire or optic fiber using a wire coating apparatus comprising a die (13) assembly comprising a mandrel assembly (16) comprising: (A) a housing (12) comprising: (1) a housing (12) wire tubular channel extending along (a) the length of the housing (12), and (b) the longitudinal centerline axis of the housing (12); (2) a fluid annular channel encircling the wire tubular channel; (3) a fluid ring (28) in fluid communication with the fluid annular channel, the fluid ring (28) positioned at one end of the housing (12); and (B) a cone-shaped tip having a wide end and a narrow end, the wide end of the tip attached to the end of the housing (12) at which the fluid ring (28) is positioned, the tip comprising: (1) a tip wire tubular channel extending along (a) the length of the tip, and (b) the longitudinal centerline axis of the tip; (2) a tip fluid channel (27) in fluid communication with the fluid ring (28); and (3) one or more nozzles (29A) in fluid communication with the tip fluid channel (27), the nozzles (29A) located at the end and extending beyond the narrow end of the tip; the housing (12) wire tubular channel and the tip wire tubular channel in open communication with one another such that a wire can pass from one to the other in a straight line and without interruption.

### FIELD OF THE INVENTION

This invention relates to a microcapillary wire coating die assembly for the production of electrical and telecommunication cable jackets with microcapillary structures.

### BACKGROUND OF THE INVENTION

Electrical and telecommunication cables are made of tough, polymeric materials designed for years of defect-free service and, accordingly, cable jackets are typically difficult to tear and require special cutting tools and trained installers for safe installation without damaging the cable. As such, there is a strong end-user need for ease of installation and “easy-peel” jackets for ready access to internal components, and easy connection of fiber optic cables, with the overall objective to reduce total system cost.

To this end, cable jackets with tear features have been developed. These structures provide easy peeling of the cable jacket so as to provide access to the cable internal components and easy connections between fiber optic cables. Products comprising tear features, and processes for making these products, are well known in the art. See, for example, WO 2012/071490 A2, US 2013/0230287 A1, U.S. Pat. Nos. 7,197,215, 8,582,940, 8,682,124, 8,909,014, 8,995,809, US 2015/0049993 A1, CN 103 665 627 A, and CN 201 698 067.

One tear feature of particular interest are microcapillaries. These structures are small diameter channels formed in the wall of the cable jacket at the time of its formation and that extend along the longitudinal axis of the cable jacket. Here too, the art is replete with disclosures regarding the nature and formation of microcapillaries. See, for example, WO 2015/175208 A1, WO 2014/003761 A1, EP 1 691 964 B 1, WO 2005/056272 A2, WO 2008/044122 A2, US 2009/0011182 A1, WO 2011/025698 A1, WO 2012/094315 A1, WO 2013/009538 A2, and WO 2012/094317 A1.

In the production of annular microcapillary products, typically the product, e.g., a cable jacket, has multiple layers two of which form around a microcapillary. Such products can be difficult to make due to the typically small, compact area of the die from which the product is formed. This, in turn, requires the use of a larger diameter die which adds to the capital and operating costs of the equipment. Of interest to the cable jacket industry is a die that will allow for the extrusion of a cable jacket comprising a single polymeric layer with embedded microcapillaries.

### SUMMARY OF THE INVENTION

In one embodiment the invention is mandrel assembly comprising:
(A) a housing comprising:
   (1) a housing wire tubular channel extending along (a) the length of the housing, and (b) the longitudinal centerline axis of the housing;
   (2) a fluid annular channel encircling the wire tubular channel;
   (3) a fluid ring in fluid communication with the fluid annular channel, the fluid ring positioned at one end of the housing; and
(B) a cone-shaped tip having a wide end and a narrow end, the wide end of the tip attached to the end of the housing at which the fluid ring is positioned, the tip comprising:
   (1) a tip wire tubular channel extending along (a) the length of the tip, and (b) the longitudinal centerline axis of the tip;
   (2) a tip fluid channel in fluid communication with the fluid ring; and
   (3) one or more nozzles in fluid communication with the tip fluid channel, the nozzles located at the end and extending beyond the narrow end of the tip;
      the housing wire tubular channel and the tip wire tubular channel in open communication with one another such that a wire can pass from one to the other in a straight line and without interruption.

In one embodiment the invention is a die assembly for applying a polymeric coating comprising microcapillaries to a wire or optic fiber, the assembly comprising the mandrel assembly described above.

In one embodiment the invention is wire coating apparatus for applying a polymeric coating comprising microcapillary structures to a wire or optic fiber, the apparatus comprising the die assembly described above.

In one embodiment the invention is a wire or optic fiber comprising a polymeric coating comprising microcapillary structure, the polymeric coating applied to the wire or optic fiber using the apparatus described above.

### BRIEF DESCRIPTION OF THE DRAWINGS

FIG. 1A is a perspective view of a die assembly for extruding a cable jacket.

FIG. 1B is a sectional view of the die assembly of FIG. 1A.

FIG. 1C is an exploded view of the die assembly of FIGS. 1A and 1B.

FIG. 2A is a perspective view of a microcapillary mandrel assembly.

FIG. 2B is a sectional view of the microcapillary mandrel assembly of FIG. 2A.

FIG. 2C is an exploded view of the microcapillary mandrel assembly of FIGS. 2A and 2B.

FIGS. 3A-3D are schematic views of the placement of microcapillary channels in the wall of a cable jacket.

FIG. 4 is a micrograph of a wire jacket with two microcapillary channels prepared with air as described in the Example.

FIG. 5 is a micrograph of a wire jacket without microcapillary channels prepared without air as described in the Example.

FIGS. 6A and 6B are photographs of inventive and comparative, respectively, coated wire tear samples from the Example.

### DETAILED DESCRIPTION OF THE PREFERRED EMBODIMENT

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

“Hybrid cable” and similar terms means a cable that contains two or more types of dissimilar transmission media within a single cable construction. Hybrid cables include, but are not limited to, cables containing a metallic wire such as copper twisted pairs and one or more optic fibers, or an optical fiber and a coaxial transmission construction.

“Cable”, “power cable” and like terms mean at least one wire or optical fiber within a sheath (e.g., an insulation covering and/or a protective outer jacket). Typically, a cable is two or more wires or optical fibers bound together, typically in a common insulation covering and/or protective jacket. The individual wires or fibers inside the sheath may be bare, covered or insulated. The cable can be designed for low, medium, and/or high voltage applications. Typical cable designs are illustrated in U.S. Pat. Nos. 5,246,783; 6,496,629 and 6,714,707.

“Conductor” denotes one or more wire(s) or fiber(s) for conducting heat, light, and/or electricity. The conductor may be a single-wire/fiber or a multi-wire/fiber and may be in strand form or in tubular form. Nonlimiting examples of suitable conductors include metals such as silver, gold, copper, carbon, and aluminum. The conductor may also be optical fiber made from either glass or plastic.

Unless stated to the contrary, implicit from the context, or customary in the art, all parts and percents are based on weight and all test methods are current as of the filing date of this disclosure.

“In fluid communication” and like terms means that adjoining devices are connected in a manner such that a fluid can pass from one to the other without interruption.

“In open communication” and like terms means that adjoining devices are connected in a manner such that an object can pass from one to the other without interruption.

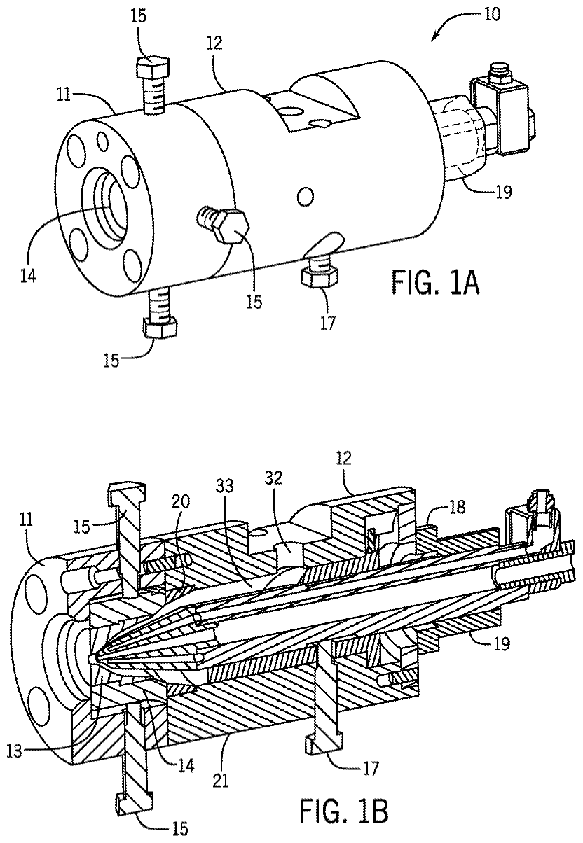

FIGS. 1A-1C illustrate a typical microcapillary wire coating apparatus. Wire coating apparatus 10 comprises end cap 11 securely attached to one end of housing 12. Fitted within end cap 11 is die 13 held in place by die retainer 14 and die retainer retaining screws 15, which are used for adjusting the wire jacket thickness uniformity and centricity.

Microcapillary mandrel assembly 16 is fitted within and extends through housing 12. Microcapillary mandrel assembly 16 is fitted within housing 12 by means of mandrel retaining screw 17, mandrel retainer 18, and adjustment screw 19. Fitted about microcapillary mandrel assembly 16 within housing 12 is resin flow deflector 20. Spacer 21 maintains the desired distance between die 13 and housing 12.

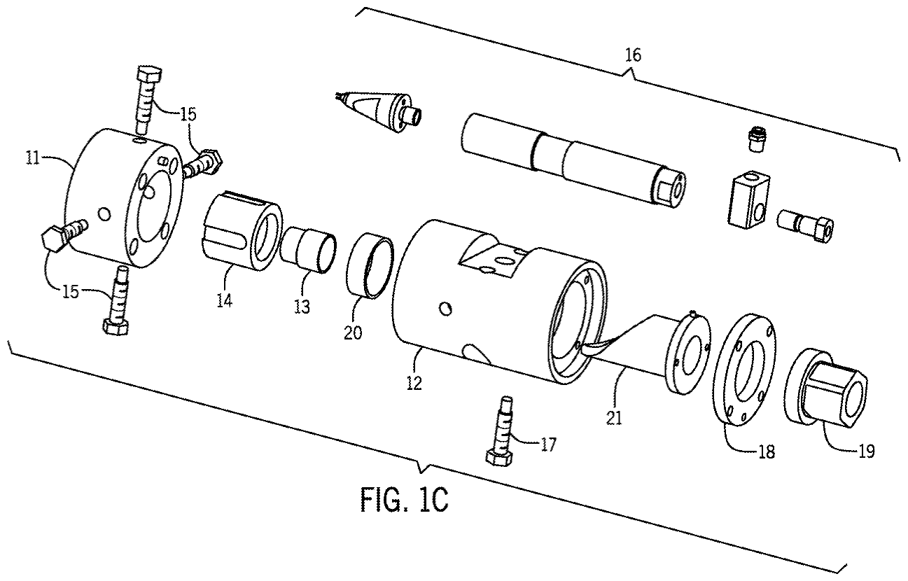

FIGS. 2A-2C illustrate one embodiment of the microcapillary mandrel assembly of this invention. Microcapillary mandrel assembly 16 comprises mandrel body 22, mandrel tip 23, mandrel adaptor 24, and mandrel adaptor retaining screw 25. Mandrel tip 23 and mandrel adaptor retaining screw 25 are attached to opposite ends of mandrel body 22 typically in a threaded relationship with a high temperature thread sealant between the opposing threads of the body and screw. Mandrel adaptor 24 is secured to mandrel body 22 by means of adaptor retaining screw 25.

Mandrel body 22 comprises wire channel 26a and fluid channel 27. Wire channel 26a is tubular and fluid channel 27 is annular, and fluid channel 27 circumscribes wire channel 26a. Both channels run the length of mandrel body 22. Fluid channel 27 provides fluid communication between mandrel adaptor 24 and mandrel tip 23, and fluid channel 27 terminates in fluid ring 28 located at the juncture of mandrel body 22 and mandrel tip 23.

Mandrel tip 23 is a cone with the narrow or tapered end equipped with nozzles 29a and 29b. These nozzles extend beyond the tapered end of mandrel tip 23. Mandrel tip 23 comprises fluid channels 30a and 30b, and these channels run the length of mandrel tip 23 and provide fluid communication between fluid ring 28 and nozzles 29a and 29b, respectively. Mandrel tip 23 is also comprises wire channel 26b that runs the length of mandrel tip 23 and is aligned with and is in open communication with wire channel 26a of mandrel body 22. Wire channel 26b is positioned along the center, longitudinal line of mandrel tip 23, and fluid channels 30a and 30b are positioned about wire channel 26b following the taper line of mandrel tip 23 beginning at fluid ring 28 and terminating at nozzles 29a and 29b, respectively. These nozzles are positioned about and beyond the tapered end of mandrel tip 23.

Mandrel adaptor 24 and mandrel adaptor retaining screw 25 comprise wire channel 26c and 26d, respectively. When assembled, wire channels 26a-26d are in alignment and in open communication with one another such that a wire can enter wire channel 26d and pass through wire channels 26a-26c in a straight line and without interruption. Mandrel adaptor 24 is also equipped with fluid port 31 which is in fluid communication with fluid channel 27 of mandrel body 22. Mandrel body 22 is also equipped with polymer melt port 32 which is in fluid communication with polymer melt channel 33 formed by the exterior surface of mandrel assembly 16 and the interior surfaces of mandrel body 22 and mandrel tip 23.

Wire coating apparatus 10 is operated in the same manner as known wire coating apparatus. Wire or previously coated wire, e.g., a wire comprising one or more wire coatings such as one or more semiconductor layer and/or insulation layers is fed into mandrel adaptor retaining screw wire channel 26d and drawn through wire channels 26a-c. The wire itself can comprise one or more strands, e.g., a single strand or a twisted pair of strands, of any conductive metal, e.g., copper or aluminum, or optic fiber.

Polymer melt is fed, typically under pressure, to mandrel body 22 through polymer melt port 32, and deflected into polymer melt channel 33 by resin flow deflector 20. Typically the wire coating apparatus is attached to the exit end of an extruder from which it receives the polymer melt. The polymer itself can be selected from any number of thermoplastic and thermoset materials, the specific material selected for its end-use performance. Exemplary materials include various functionalized and nonfunctionalized polyolefins such as polyethylene, polypropylene, ethylene vinyl acetate (EVA), and the like. The polymer melt flows through polymer melt channel 33 until it flows around nozzles 29a-b and is applied to the surface of the wire.

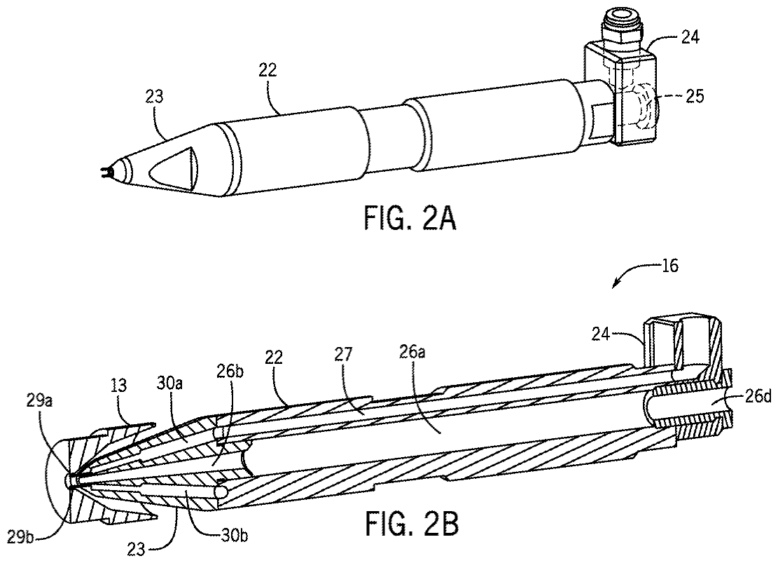

Fluid, typically air but any gas, liquid or melt can be used, enters, typically under pressure, fluid channel 27 through fluid port 31 of mandrel adaptor 24. The fluid moves through fluid channel 27 of mandrel body 22 into fluid ring 28 from which it enters fluid channels 30a-b of mandrel tip 23. The fluid exits channels 30a-b through nozzles 29a-b, respectively, into the polymer melt as the melt is applied to the wire. Because the nozzles extend beyond the end of the cone of mandrel tip 23, the fluid from nozzles 29a-b enters the wire covering and as the polymer melt solidifies, forms microcapillaries in the covering. The number of microcapillaries formed is a function of the number of nozzles extending beyond the end of the cone of the mandrel tip. Likewise, the placement of the microcapillaries in the wire covering is a function of the placement of the nozzles on the mandrel tip. FIGS. 3A-D illustrate four placement patterns in a cable jacket formed with a mandrel tip equipped with two nozzles. In each figure the microcapillaries are opposite one another, but in FIG. 3A they are centered in the jacket wall, while in FIG. 3B they are on the inner surface of the jacket wall, while in FIG. 3C they are near the outer surface of the jacket wall, while in FIG. 3D they are on the outer surface of the jacket wall (and thus actually form a groove in the outer surface of the jacket wall).

The placement of the nozzles such that they extend beyond the end of the cone of the mandrel tip allows for the formation of microcapillaries in the wall of the wire coating. This, in turn, allows for the extrusion of a single layer of wire coating with microcapillaries which, in turn, allows for the design of a die with a smaller diameter as compared to a die for extruding multiple layers with microcapillaries formed between the layers. This, in turn, can reduce both the capital and operating costs associated with extruding a coating about a wire.

The microcapillary geometry can be optimized to fit covering thickness and achieve desired ease of tearing with minimum impact on mechanical properties. The microcapillaries can be discontinuous or intermittent so to enable jacket tearing over a specific length. The microcapillaries can be placed at desired radial positions on the jacket circumference (as illustrated in FIGS. 3A-D). The microcapillaries can be marked for ease of finding by printing or indentation or embossing the exterior surface of the wire covering. The microcapillary can be also filled with a substantially weaker non-covering polymeric material, such as an elastomer, by using a secondary extruder to pump the polymer melt into microcapillary channels. The short axis of microcapillary should not exceed the thickness of the jacket or cable layer containing it. The microcapillary geometry is controlled by flow rate and pressure, e.g., air flow rate and air pressure.

The following example is a further illustration of an embodiment of this invention.

### EXAMPLE

The wire coating apparatus used in this example is described in FIGS. 1A-C and 2A-C. The resin flow deflector distributes the incoming polymer melt into uniform flow across the annular channel. Air is introduced to microcapillary mandrel through the mandrel adaptor, and it is transported to the mandrel tip via hollow channel. The air is divided into two streams, and then it arrives at the microcapillary nozzles. The polymer melt wraps around microcapillary nozzles and meets with air at the die exit.

The wire coating apparatus was a Davis-Standard wire coating line comprised of a single-screw extruder, a wire stranding unit, a microcapillary tubing type cross-head die, an air-line for providing air flow to the microcapillary channels, a series of water bathes with temperature controllers, and a filament take-up device.

The polymer resin used is a medium density polyethylene (MDPE) compound (AXELERON™ GP 6548 BK CPD) with a density 0.944 g/cm³ and a melt flow rate of 0.7 g/10min (190° C., 2.16 kg). The temperature profile of the extrusion line is reported in Table 1. The air pressure was initially set to 20 pounds per square inch (psi) (137,896 Pascals) and air flow rate was set to 84.7 cc/min for starting up the extrusion. Using a conventional wire stranding unit, a 14 gauge (0.064 inch) copper wire was drawn through the microcapillary wire coating die. The wire was preheated to 225-250° F. before arriving at the die. Polymer pellets were fed into the extruder through a hopper, and then melted and pumped into the microcapillary cross-head die. The molten polymer flowed around microcapillary nozzles close to the die exit and was applied onto the surface of the copper wire. This coated wire was threaded through a series of water cooling troughs. The wire thus manufactured was collected on a filament take-up device. The air pressure and air flow rate were slowly regulated down so that that the extrusion coating process could be run in the steady state. For the inventive samples, the screw speed was changed from 18.5 revolutions per minute (rpm) to 45.75 rpm, and the line speed varied from 100 feet per minute (ft/min) to 300 ft/min (30.48 meters per minute (m/min) to 91.44 m/min). The air pressure was kept at 10 psi (68,948 Pascals), while the air flow rate varied from 15 cc/min to 23.1 cc/min.

For comparative samples, the air was shut off but the same extrusion conditions as inventive samples were kept.

TABLE 1
Temperature Profile of Extrusion Line for Making Microcapillary Wire Coating

| Zone #1 | Zone #2 | Zone #3 | Zone #4 | Zone #5 | Heat | Die 1 | Die 2 |
|---|---|---|---|---|---|---|---|
| (° C.) | (° C.) | (° C.) | (° C.) | (° C.) | (° C.) | (° C.) | (° C.) |
| 160 | 179 | 193 | 210 | 210 | 216 | 216 | 216 |

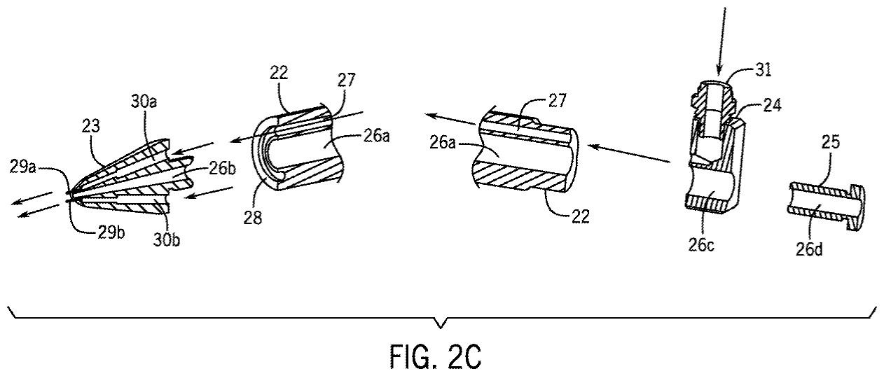

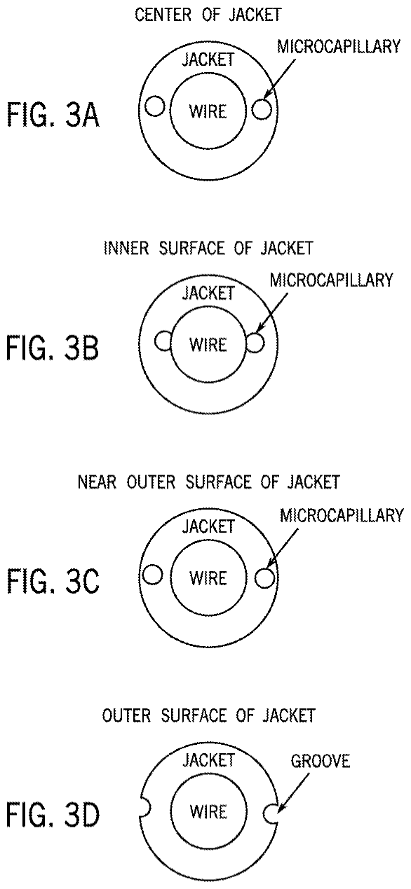

The detailed processing conditions and jacket and microcapillary dimension are given in Table 2. FIGS. 4 and 5 show examples of inventive microcapillary wire jacket, which was prepared by the conditions of a screw speed of 30.5 rpm, a line speed of 200 ft/min (60.96 m/min), an air pressure of 10 psi (68,948 Pascals) and air flow rate of 15 cc/min, and comparative wire jacket, which was prepared by the conditions of a screw speed of 30.5 rpm and a line speed of 200 ft/min (60.96 m/min).

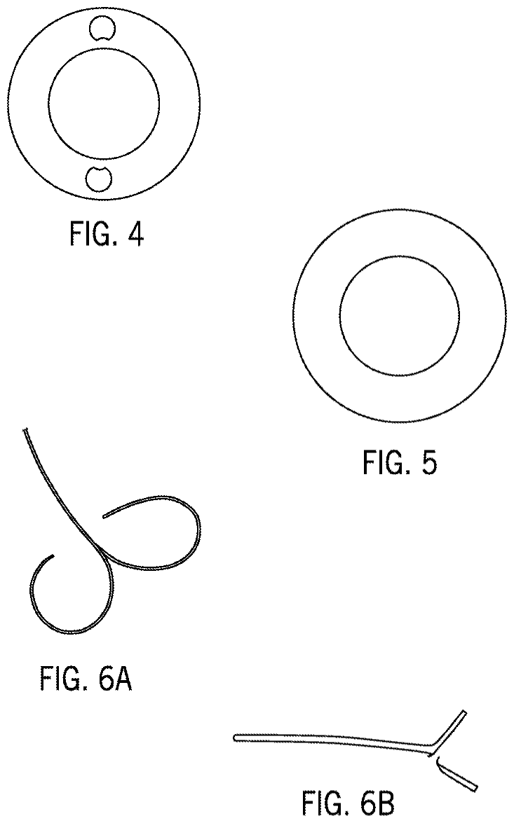

The strip test was conducted to measure the tear strength of inventive microcapillary jackets and comparative solid jackets. The specimens were cut by 1.0 inch (2.56 cm) opening to make the lips. As reported in Table, Comparative 11A solid jacket has the highest strip force of 13.18 (pound-foot (lbf) (58.63 Newtons (N)), while Inventive 7A with two microcapillary channels shows the lowest strip force of 3.37 lbf (15 N). This represents 75% reduction in strip force for Inventive 7A as compared with Comparative 11A. Microcapillary channels in Inventive 9A guide the tearing path and result in clean stripping with lower force, as displayed in FIG. 6A. In contrast, Comparative 11A solid jacket showed the breakage in a non-controlled fashion (FIG. 6B). Also as shown from Table 2, there is a strong correlation between strip force and total microcapillary wall thickness. Smaller wall thickness results in lower strip force.

TABLE 2
Processing Conditions, Jacket and Microcapillary Dimension, and Tear Strength of
Microcapillary Wire Jackets and Comparative Solid Jackets

| | | | | | | | | | | Strip | |
|---|---|---|---|---|---|---|---|---|---|---|---|
| | | | | | | | | | Total | Force, | |
| | | | | Air | Largest | Smallest | Jacket | | Microcapillary | Avg. | StdDev- |
| | Screw | Line | Air | Flow | Jacket | Jacket | Inner | Total | Wall | Peak | Peak |
| | Speed | Speed | Pressure | Rate | Thickness | Thickness | Diameter | Microcapillary | Thickness | Load | Load |
| Sample # | (rpm) | (ft/min) | (psi) | (ccm) | (μm) | (μm) | (μm) | Area (μm²) | (μm) | (lbf) | (lbf) |
| Inventive 1A | 18.5 | 100 | 10 | 23.1 | 913 | 691 | 1653 | 331924 | 609 | 4.21 | 0.32 |
| Inventive 1B | 18.5 | 100 | 10 | 23.1 | 921 | 665 | 1608 | 332930 | 581 | 3.88 | 0.29 |
| Inventive 2A | 18.5 | 100 | 10 | 18.3 | 833 | 574 | 1589 | 198252 | 570 | 3.86 | 0.04 |
| Inventive 2B | 18.5 | 100 | 10 | 18.3 | 586 | 683 | 1684 | 123428 | 711 | 3.65 | 0.09 |
| Inventive 3A | 22.5 | 100 | 10 | 18.3 | 571 | 676 | 1677 | 122803 | 707 | 4.37 | 0.30 |
| Inventive 3B | 22.5 | 100 | 10 | 18.3 | 1130 | 792 | 1617 | 512099 | 533 | 4.27 | 0.28 |
| Inventive 4A | 22.5 | 100 | 10 | 15 | 1076 | 726 | 1554 | 443609 | 549 | 4.57 | 0.06 |
| Inventive 5A | 26.5 | 100 | 10 | 15 | 1330 | 715 | 1558 | 428200 | 558 | 4.84 | 0.23 |
| Inventive 6A | 30.5 | 100 | 10 | 15 | 1436 | 842 | 1629 | 461629 | 538 | 5.80 | 0.19 |
| Inventive 7A | 30.5 | 200 | 10 | 15 | 731 | 550 | 1609 | 222874 | 478 | 3.37 | 0.10 |
| Inventive 8A | 45.75 | 300 | 10 | 15 | 751 | 552 | 1669 | 179180 | 544 | 3.77 | 0.22 |
| Inventive 9A | 45.75 | 300 | Air Off | | 687 | 635 | 1593 | 19951 | 960 | 3.70 | 0.24 |
| Inventive 9B | 45.75 | 300 | Air Off | | 672 | 546 | 1633 | 15665 | 971 | 5.38 | 1.13 |
| Comparative 10A | 30.5 | 200 | Air Off | | 655 | 701 | 1588 | | | 6.05 | 0.64 |
| Comparative 11A | 30.5 | 100 | Air Off | | 1143 | 1136 | 1646 | | | 13.18 | 0.47 |
| Comparative 12A | 26.5 | 100 | Air Off | | 989 | 988 | 1594 | | | 11.43 | 0.42 |
| Inventive 13A | 26.5 | 100 | 10 | 15 | 1173 | 761 | 1586 | 359560 | 751 | 5.15 | 0.34 |

What is claimed is:

1. A mandrel assembly comprising:
(A) a housing comprising:
(1) a housing wire tubular channel extending along (a) the length of the housing, and (b) the longitudinal centerline axis of the housing;
(2) a fluid annular channel encircling the wire tubular channel;
(3) a fluid ring in fluid communication with the fluid annular channel, the fluid ring positioned at one end of the housing; and
(B) a cone-shaped tip having a wide end and a narrow end, the wide end of the tip attached to the end of the housing at which the fluid ring is positioned, the tip comprising:
(1) a tip wire tubular channel extending along (a) the length of the tip, and (b) the longitudinal centerline axis of the tip;
(2) a tip fluid channel in fluid communication with the fluid ring; and
(3) one or more nozzles in fluid communication with the tip fluid channel, the nozzles located at the end and extending beyond the narrow end of the tip;
the housing wire tubular channel and the tip wire tubular channel in open communication with one another such that a wire, hybrid cable or optical fiber can pass from one to the other in a straight line and without interruption.

2. A die assembly for the extrusion of a polymeric product comprising microcapillary structures, the assembly comprising the mandrel assembly of claim 1.

3. A wire coating apparatus for applying a polymeric coating comprising microcapillary structures to a wire, hybrid cable or optic fiber, the apparatus comprising the die assembly of claim 2.

4. A wire, hybrid cable or optic fiber comprising a polymeric coating comprising microcapillary structures, the polymeric coating applied to the wire or optic fiber using the apparatus of claim 3.
